(19) United States
(12) Patent Application Publication
(10) Pub. No.: US 2003/0131005 A1
(43) Pub. Date: Jul. 10, 2003

(54) Method and apparatus for automatic pruning of search engine indices

(75) Inventor: Richard Edmond Berry, Georgetown, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/045,111

(22) Filed: Jan. 10, 2002

(51) Int. Cl. G06F 7/00

(52) U.S. Cl. 707/10

(57) ABSTRACT

A method, apparatus, and computer instructions for pruning search engine indices. A notification is received from a client browser that a Web page retrieval error occurred for a Web page or that the Web page no longer contains selected keywords. In response to receiving the notification, the Web page is automatically deleted from the search engine indices. This automatic deletion may occur upon receiving the notice from the browser or after receiving some threshold number of notifications from browsers.

### BACKGROUND OF THE INVENTION

1. Technical Field

The present invention relates generally to an improved data processing system, and in particular to a method and apparatus for processing data. Still more particularly, the present invention provides a method, apparatus, and computer instructions for managing entries or indices for Web pages to automatically eliminate entries or indices for deleted or out-of-date pages.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database. In exploring or “surfing” the Web, users often access search engines to find desired content. A search engine is software that searches an index in response to receiving keywords or phrases and returns a result. Examples of search engines include, for example, Google, AltaVista, WebCrawler, AskJeeves, Metacrawler, and Northern Light. For example, a user looking for Web pages about recipes for pies would access a page for a search engine. At this Web page, the user would enter search terms, such as “pie” and “recipe”. A request is sent to the search engine with the search terms. Upon receiving the request, the search engine will perform a search in its index. An index is a searchable catalog of documents created by search engine software. A search engine may “crawl” or “spider” a Web site to identify different Web pages for the index. In essence, a search engine will follow links found on Web pages in a Web site to identify other pages and place these pages in the index. An index is also referred to as a “catalog”. Index is often used as a synonym for search engine. Index is commonly pluralized as “indices”. The results of the search are typically a list of Web pages or Web sites, which are returned to the user. These results are presented in the browser as a list or a series of links.

The user may then retrieve or access Web pages by selecting links from the results. Sometimes, a selected link may lead to a “dead” page. This situation may be disappointing or annoying to a user depending on how many links in the results are out-of-date. In this case, the page may have been deleted from the server hosting the page, but this change has not been updated in the database or index used by the search engine. When a page is absent or cannot be retrieved, an HTTP 404 error is returned to the user. Search engines periodically search or “crawl” the Web to update indices, but this task may take days to complete. Thus, most indices are almost always out-of-date to some degree.

Therefore, it would be advantageous to have an improved method and apparatus for automatically pruning indices in an index to remove out-of-date entries.

### SUMMARY OF THE INVENTION

The present invention provides a method, apparatus, and computer instructions for pruning search engine indices. A notification is received from a client browser that a Web page retrieval error occurred for a Web page or that the Web page no longer contains selected keywords. In response to receiving the notification, the Web page is automatically deleted from the search engine indices. This automatic deletion may occur upon receiving the notice from the browser or after receiving some threshold number of notifications from browsers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of a browser program in accordance with a preferred embodiment of the present invention;

FIG. 5 is a diagram illustrating data flow used in automatically pruning or updating indices in a search engine index in accordance with a preferred embodiment of the present invention;

FIG. 6 is a diagram illustrating a notification in accordance with a preferred embodiment of the present invention;

FIG. 7 is a flowchart of a process used to generate notifications in accordance with a preferred embodiment of the present invention;

FIG. 8 is a flowchart of a process used for generating a notification for an out-of-date Web page in accordance with a preferred embodiment of the present invention;

FIG. 9 is a flowchart of a process used for automatically pruning indices in a search engine index in accordance with a preferred embodiment of the present invention; and

FIG. 10 is a flowchart of a process used for managing bookmarks in a browser in accordance with a preferred embodiment of the present invention.

### DETAILED DESCRIPTION OF THE PREFERRED EMBODIMENT

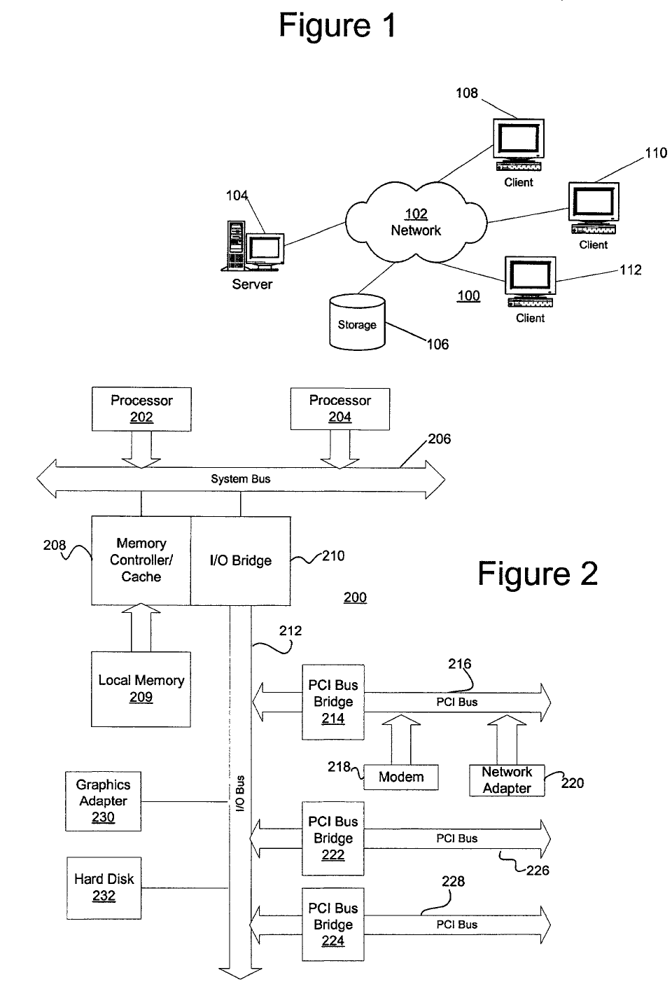

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. In these examples, server 104 acts as a search engine or Web server to provide a user with the capability to search for Web pages and/or retrieve Web pages. The present invention provides a mechanism in which the HTTP protocol may be augmented to support communications between a browser and a search engine. A search engine located on server 104 identifies itself as a search engine to a browser on a client, such as client 108. If the browser on client 108 encounters a bad link, such as one leading to a missing Web page, then a notification may be sent to the search engine and used to update the index. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may include instructions for a search engine as well as instructions for automatic pruning for out-of-date indices in an index used by the search engine. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y, running the Advanced Interactive Executive (AIX) operating system or LINUX operating system.

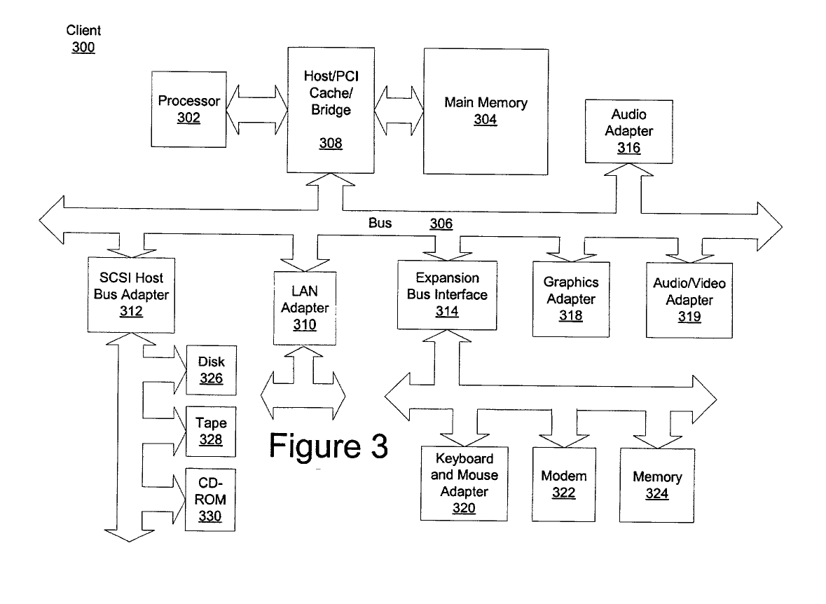

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

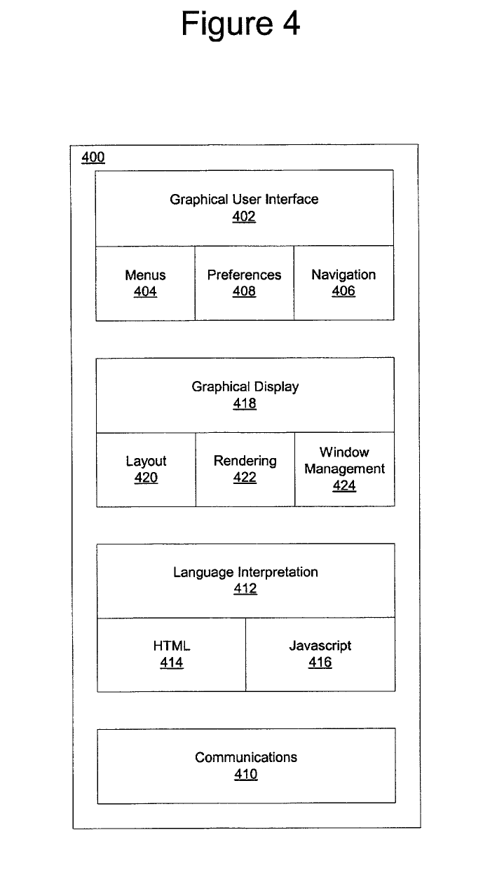

Turning next to FIG. 4, a block diagram of a browser program is depicted in accordance with a preferred embodiment of the present invention. A browser is an application used to navigate or view information or data in a distributed database, such as the Internet or the World Wide Web. Browser 400 in these examples includes instructions to allow it to generate notifications and send those notifications to a search engine supplying links, which lead to dead pages are encountered.

In this example, browser 400 includes a user interface 402, which is a graphical user interface (GUI) that allows the user to interface or communicate with browser 400. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select web sites for viewing. For example, navigation 406 may allow a user to see a previous page or a subsequent page relative to the present page. Preferences such as those illustrated in FIG. 4 may be set through preferences 408.

Communications 410 is the mechanism with which browser 400 receives documents and other resources from a network such as the Internet. Further, communications 410 is used to send or upload documents and resources onto a network. In the depicted example, communications 410 uses HTTP. Other protocols may be used depending on the implementation. In these examples, processes implemented as instructions for generating notifications of bad links may be implemented in communications 410.

Documents that are received by browser 400 are processed by language interpretation 412, which includes an HTML unit 414 and a JavaScript unit 416. Language interpretation 412 will process a document for presentation on graphical display 418. In particular, HTML statements are processed by HTML unit 414 for presentation while JavaScript statements are processed by JavaScript unit 416.

Graphical display 418 includes layout unit 420, rendering unit 422, and window management 424. These units are involved in presenting web pages to a user based on results from language interpretation 412.

Browser 400 is presented as an example of a browser program in which the present invention may be embodied. Browser 400 is not meant to imply architectural limitations to the present invention. Presently available browsers may include additional functions not shown or may omit functions shown in browser 400. A browser may be any application that is used to search for and display content on a distributed data processing system. Browser 400 may be implemented using known browser applications, such as Netscape Navigator or Microsoft Internet Explorer. Netscape Navigator is available from Netscape Communications Corporation while Microsoft Internet Explorer is available from Microsoft Corporation.

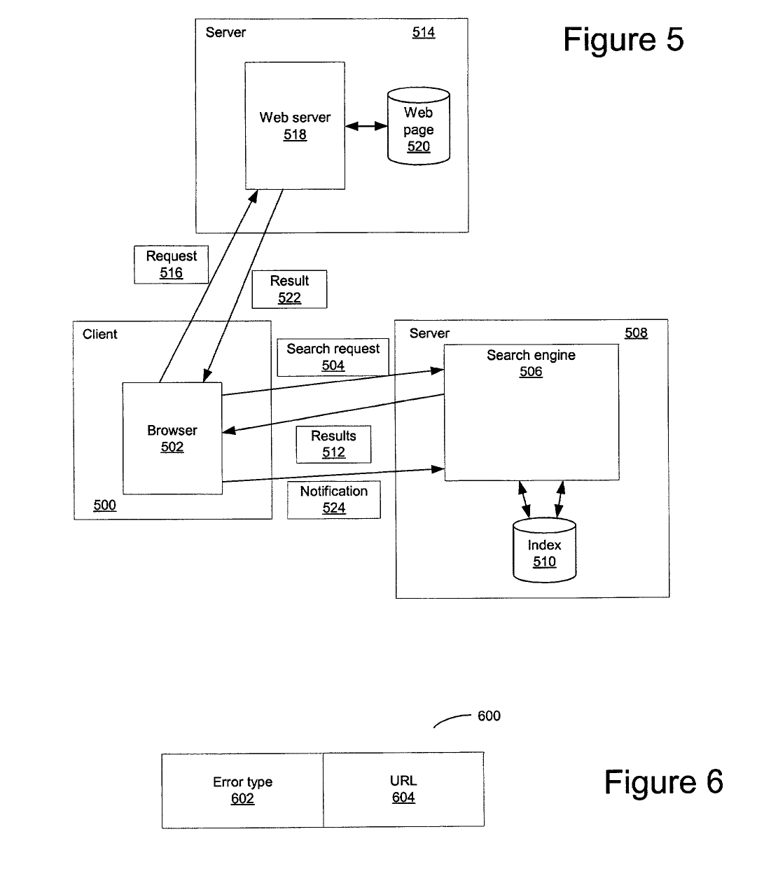

Turning next to FIG. 5, a diagram illustrating data flow used in automatically pruning or updating indices in a search engine index is depicted in accordance with a preferred embodiment of the present invention. In this example, client 500 includes a browser 502. Client 500 may be implemented using data processing system 300 in FIG. 3 while browser 502 may be implemented using browser 400 in FIG. 4. Search request 504 is generated by browser 502 and sent to search engine 506 located in server 508. Search request 504 may include search terms, such as keywords or phrases. Server 508 may be implemented using data processing system 200 in FIG. 2 in these examples. Search engine 506 searches index 510 for matches to search request 504. Index 510 is a searchable catalog of documents created by search engine software. This index is stored in a data structure, such as a database. Index 510 may contain selected words or tags for a Web page or in some cases may be a full-text index, which is an index containing every word of every document cataloged. The type of search performed by search engine 506 varies depending on the particular type of search engine. For example, a concept search may be performed. A concept search is a search for documents related conceptually to a word, rather than specifically containing the word itself. Alternatively, a fuzzy search may be employed by search engine 506. A fuzzy search is a search that will find matches even when words are only partially spelled or misspelled. Also, a keyword or key phrase search may be performed by search engine 506. A keyword or key phrase search is a search for documents containing one or more words or phrases that are specified by a user. Results 512, generated from the search, are sent to Web browser 502 for display. In these examples, the HTTP protocol is augmented to allow search engine 506 to identify itself to browser 502 as being capable of receiving notifications that identify out-of-date Web pages or retrieval errors occurring in requesting Web pages. Browser 502 will then send notifications to search engine 506. Of course, this notification mechanism may apply to any supplier of links to browser 502. This information may be sent with results 512 or in a separate message to browser 502, depending on the particular implementation.

Results 512 are displayed within browser 502. These results are typically displayed as a set of links, which may be selected to retrieve Web pages. These Web pages may be located at server 508 or in another server, such as server 514. Server 514 also may be implemented using data processing system 200 in FIG. 2. In this example, a selection of a link generates request 516 and is sent to Web server 518 in server 514. In response to receiving a request, Web server 518 searches Web page database 520 to determine whether the requested Web page is present. The result of this search is returned as result 522 to browser 502. If the Web page is found, result 522 contains the Web page and the Web page is displayed by browser 502. If the Web page was not found, then an HTTP 404 error is returned in result 522. This error code or some other message may be displayed to the user to indicate that the page requested using the selected link is no longer present on Web server 518.

In response to such an error, browser 502 generates notification 524 and sends it to search engine 506. This notification lets search engine 506 know that a particular link resulted in an HTTP 404 error. Search engine 506 may then delete the Web page from index 510. This may be performed automatically when notification 524 is received. Alternatively, search engine 506 may wait to accumulate some minimum number of notifications prior to deleting the page. Such a use of a threshold may ensure that temporary problems at the hosting server, such as server 514, do not lead to undesired page deletions. Further, notification 524 may be generated in response to other factors indicating that the page is out-of-date. For example, browser 502 may compare the Web page to the search terms or phrases to see whether a correspondence is present. If some number of keywords are missing from the page, this Web page may be identified as being out-of-date by browser 502 with this error being placed into notification 524. In this manner, entries or indices within index 510 may be pruned or kept up to date on a more frequent basis.

Further, browser 502 may employ a similar pruning or removal process to remove dead links from a bookmark or favorite list.

Turning next to FIG. 6, a diagram illustrating a notification is depicted in accordance with a preferred embodiment of the present invention. Notification 600 in these examples includes error type 602 and URL 604. Error type 602 indicates the type of error that occurred, such as an HTTP 404 error. URL 604 identifies the link through which this error occurred. Error type 602 also may include other types of errors, such as an error that the page does not include all of the search terms or one or more of the search terms. Of course this type of error may be ignored by search engine 506 depending on the type of searching mechanism used. For example, this type of error would not be useful if a concept search is employed.

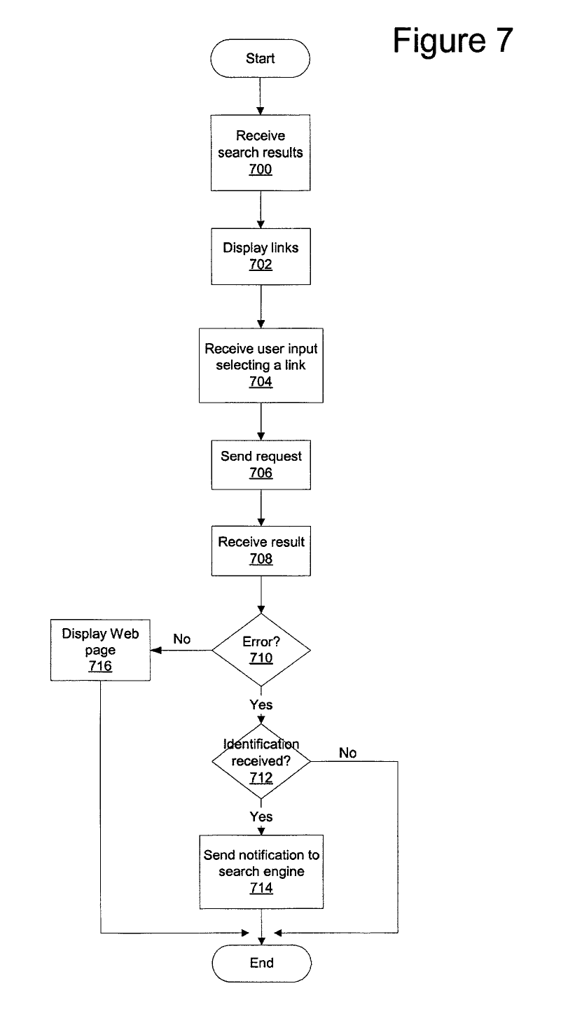

With reference now to FIG. 7, a flowchart of a process used to generate notifications is depicted in accordance with a preferred embodiment of the present invention. The process illustrated in FIG. 7 may be implemented in a browser, such as browser 400 in FIG. 4.

The process begins by receiving search results (step 700). The search results take the form of a Web page containing links to Web pages matching or corresponding to the search as identified by the search engine. These links are displayed (step 702). A user input selecting a link is received (step 704). In response to the user input, a request is sent using the URL in the link (step 706). This request is sent to the Web server in the URL identified by the link. The result is received (step 708). The result may be a Web page or possibly an error message.

A determination is then made as to whether an error has occurred (step 710). If an error has occurred, a determination is made as to whether an identification has been received (step 712). This identification is an indication that may be sent by the search engine to identify itself as a supplier of links that desires to receive notifications when a retrieval error occurs or when an out-of-date page is found. This identification may be received with the results returned from the search engine or as a separate message. In these examples, the message takes the form of a notification, such as notification 600 in FIG. 6.

If the identification has been received, a notification is sent to the search engine (step 714) with the process terminating thereafter. The identification supplied by the search engine may not be necessary depending on the particular implementation. For example, if the browser simply responds to the supplier, the supplier can decide if the response is useful or not. In the case of a search engine, such a response is useful, and it may be for other types of Web applications as well. Otherwise, the supplier would simply ignore the browser's notification. Turning again to step 710, if an error has not occurred, the Web page is displayed (step 716) and the process terminates thereafter. With reference again to step 712, if an identification has not been received, the process terminates.

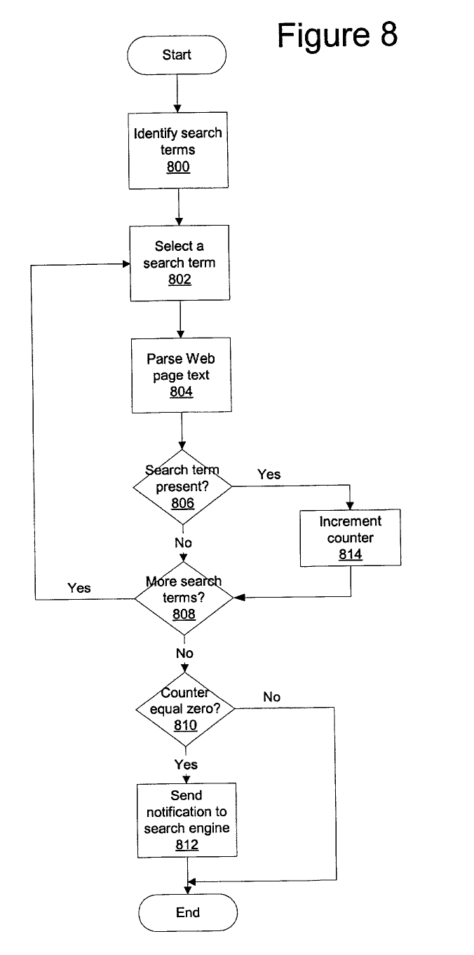

Turning next to FIG. 8, a flowchart of a process used for generating a notification for an out-of-date Web page is depicted in accordance with a preferred embodiment of the present invention. The process illustrated in FIG. 8 may be implemented in a browser, such as browser 400 in FIG. 4. This process may be performed on each Web page retrieved from links returned in a search result.

The process begins by identifying search terms (step 800). These search terms are those used to generate the results. A search term is selected for use in processing the Web page (step 802). Web page text is parsed for the selected search term (step 804). A determination is made as to whether the search term is present (step 806). If the search term is absent, a determination is made as to whether additional search terms are present (step 808). If additional search terms are not present, a determination is made as to whether the counter is equal to zero (step 810). If the counter is equal to zero, a notification is sent to the search engine (step 812) with the process terminating thereafter. Such a result means that none of the search terms were present in the Web page. Depending on the type of search mechanism used by the search engine, this result means that the Web page is out-of-date with respect to the indexing of this page in the search engine index; i.e., the supplier (search engine in these examples) decides whether or not to continue associating the page with these keywords based on the count.

With reference again to step 810, if the counter is equal to zero, the process terminates. Turning again to step 808, if additional search terms are present, the process returns to step 802 as described above. Turning now to step 806, if the search term is present, the counter is incremented (step 814) and the process proceeds to step 808 as described above.

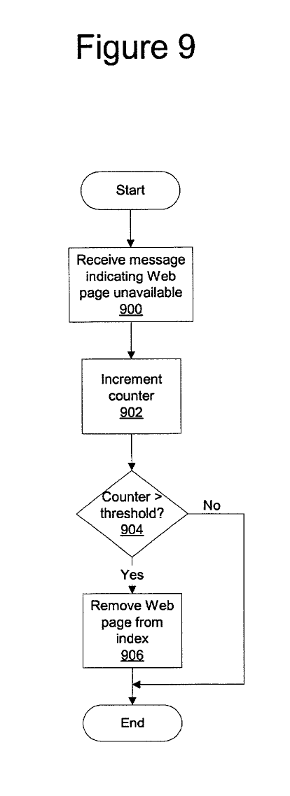

With reference now to FIG. 9, a flowchart of a process used for automatically pruning indices in a search engine index is depicted in accordance with a preferred embodiment of the present invention. The process illustrated in FIG. 9 may be implemented in a search engine, such as search engine 506 in FIG. 5, or any other Web server application that supplies pages containing links to client browsers.

The process begins by receiving a message indicating the Web page is unavailable (step 900). The counter is incremented (step 902). A determination is then made as to whether the counter is greater than the threshold (step 904). This threshold value may be any number, but is typically selected to avoid removing or deleting a Web page that may be unavailable due to a temporary problem at the server hosting the Web page. Further, this counter may be reset after some period of time depending on the particular implementation. If the counter is greater than the threshold, the Web page is removed from the index (step 906) and the process terminates thereafter.

With reference again to step 904, if the counter is not greater than the threshold, the process terminates.

With respect to the threshold used in step 904, this threshold may be set depending on the popularity or number of hits a Web page receives. A popular Web page may have a higher threshold than a less popular Web page because if a Web page is unavailable on a temporary basis, more HTTP 404 messages will be present for a more popular Web page than a less popular Web page. Further, a threshold may be adjusted for the time of day. Such adjustments may take into account that heavily visited pages will have more attempts or hits during peak times.

Additionally, a feedback mechanism may be implemented in which a server identifying a Web page that exceeds a threshold will send a message to the server hosting the Web page. This message would ask whether a deletion of the Web page is appropriate. Alternatively, if a Web page is identified as exceeding the threshold, the server maintaining the index may request the Web page prior to deleting it from the index. If in this last request, the search engine receives an HTTP 404 error, then the Web page is removed from the index. If the Web page is retrievable, then the counter counting the number of errors may be reset.

Further, monitoring or querying of a server condition may be used. In this case, the server maintaining the index may monitor or query servers hosting Web pages to determine the status of those servers. This status may be used in determining whether to ignore the receipt of a notification that an HTTP 404 error has occurred.

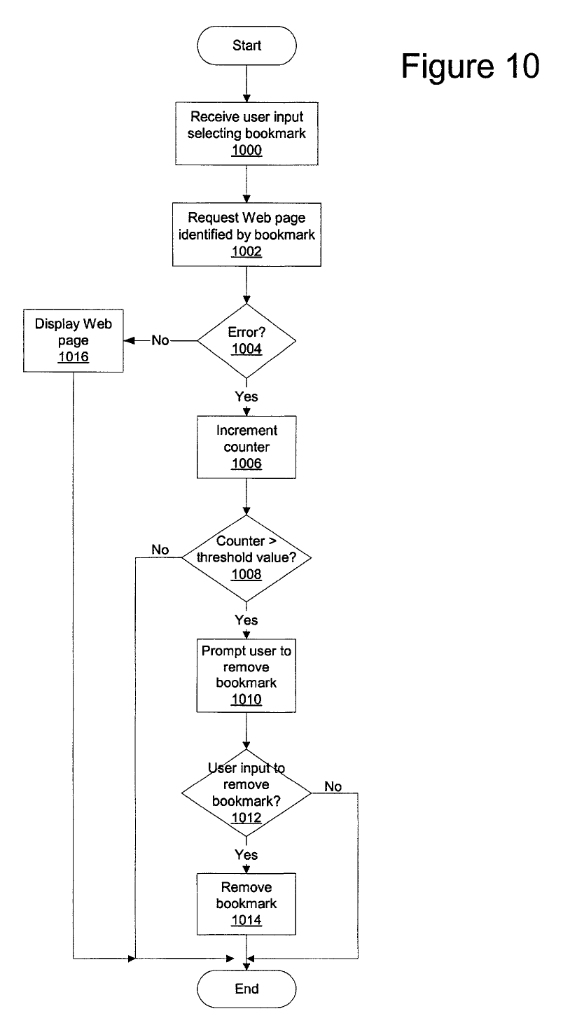

Turning next to FIG. 10, a flowchart of a process used for managing bookmarks in a browser is depicted in accordance with a preferred embodiment of the present invention. The process illustrated in FIG. 10 may be implemented in browser, such as browser 400 in FIG. 4.

The process begins by receiving user input selecting a bookmark (step 1000). A Web page identified by the bookmark is requested (step 1002). A determination is then made as to whether an error has occurred (step 1004). In these examples, the error is an HTTP 404 error resulting from the inability of the server to return the requested Web page. If an error has occurred, the counter is incremented (step 1006).

A determination is then made as to whether the counter is greater than the threshold value (step 1008). If the counter is greater than the threshold value, the user is prompted to remove the bookmark (step 1010). Next, a determination is made as to whether there has been a user input to remove the bookmark (step 1012). If the user input requests that the bookmark be removed, the bookmark is removed (step 1014) and the process terminates thereafter. Alternatively, a bookmark may be automatically removed without prompting the user depending on the particular implementation. This threshold may be set using any value including a value of 1 to generate a prompt on the first occurrence of an error.

Turning again to step 1012, if the user input does not request that the bookmark be removed, the process terminates. With reference again to step 1008, if the counter is not greater than the threshold value, the process terminates. With reference now to step 1004, if an error has not occurred, the Web page is displayed (step 1016) and the process terminates thereafter. Thus, the present invention provides a method, apparatus, and computer instructions for managing entries or indexes in an index. The mechanism of the present invention provides for automatic pruning of out-of-date indices. This mechanism may effectively employ every computer accessing the Web as an agent for updating the index. In this manner, indexes for search engines may be kept more up-to-date by using this process in conjunction with other process, such as searching Web sites and indexing Web pages at these Web sites.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the depicted examples are implemented using a search engine. The mechanism of the present invention could be implemented in other systems employing lists of links, such as a Web portal. A Web portal is software, which provides links to various other Web sites. Additionally, the depicted examples illustrate the use of an HTTP 404 error as identifying a Web page as being unavailable. Of course, the mechanism of the present invention may be used with other types of errors or even with other types of protocols. For example, when a Web page is moved permanently, the server may return an HTTP 301 error code. If an HTTP 403 code is received, the page also may be removed from the index since the server refuses to allow access to this page. These and any other types of errors that may indicate the long term unavailability of a Web page may be used in determining whether to remove a Web page from an index. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for pruning search engine indices, the method comprising:
receiving a notification from a client browser that a Web page retrieval error occurred for a Web page or that the Web page no longer contains selected keywords; and
automatically deleting the Web page from the search engine indices in response to receiving the notification.

2. The method of claim 1, wherein the step of automatically deleting is initiated if the notification results in a minimum number of notifications being received for the Web page.

3. The method of claim 1 further comprising:
receiving a search request from the client browser, wherein the search request contains the selected keywords;
searching the search engine indices for matches to the selected keywords to form a search; and
sending a result of the search to the client browser.

4. The method of claim 3, wherein the result includes an indication that the data processing system includes a search engine to cause the client browser to send the notification to the data processing system.

5. The method of claim 4, wherein the search request includes other keywords in addition to the selected keywords.

6. The method of claim 1, wherein the retrieval error indicates that the Web page is absent.

7. The method of claim 1, wherein the method is located in one of a search engine or a Web portal.

8. A method in a data processing system for managing entries in a Web page database, the method comprising:
receiving a notification from a client browser that a retrieval error occurred for a Web page; and
automatically deleting an entry associated with the Web page from the Web page database in response to receiving the notification.

9. The method of claim 8, wherein the step of automatically deleting the entry occurs only if the notification causes a number of notifications received for the entry to exceed a threshold value.

10. The method of claim 8 further comprising:
receiving a search request from the client browser;
searching the Web page database for matches to the request to generate a result; and
sending the result generated from searching the Web page database to the client browser, wherein the result includes an indicator that the data processing system includes a search engine to cause the client browser to return the notification.

11. The method of claim 8, wherein the notification is a first type of notification and further comprising:
receiving a second type of notification from a client browser that at least one selected search term is absent from the Web page; and
automatically deleting an entry associated with the Web page from the Web page database in response to receiving the second type of notification.

12. The method of claim 8, wherein the method is located in one of a search engine or a Web portal.

13. A method in a data processing system for removing a faulty entry from an index of Web pages, the method comprising:
receiving a result from a server, wherein the result includes links to Web pages corresponding to a search request;
requesting a Web page identified by a link in the links in response to a user input selecting the link; and
sending a notification to the server in response to an error occurring in retrieving the Web page.

14. The method of claim 13 further comprising:
receiving the Web page to form a retrieved Web page; and
sending a notification to the server in response to an absence of selected keywords in the Web page.

15. The method of claim 13, wherein the method is performed by a browser.

16. A method in a data processing system for managing a set of bookmarks for a browser, the method comprising:
sending a request for a Web page in response to a selection of a bookmark from the set of bookmarks, wherein the bookmark is associated with the Web page; and
responsive to an error in retrieving the Web page, selectively removing the bookmark.

17. The method of claim 16, wherein the selectively removing step comprises:
determining whether the error has occurred more than a selected number of times; and
responsive to the error occurring more than the selected number of times, removing the bookmark from the set of bookmarks.

18. The method of claim 16, wherein the selectively removing step comprises:
determining whether the error has occurred more than a selected number of times; and
responsive to the error occurring more than a selected amount of times, generating a user prompt to remove the bookmark.

19. The method of claim 18, wherein the selectively removing step further comprises:
removing the bookmark in response to a user input to remove the bookmark.

20. A data processing system for pruning search engine indices, the data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a notification from a client browser that a Web page retrieval error occurred for a Web page or that the Web page no longer contains selected keywords; and automatically delete the Web page from the search engine indices in response to receiving the notification.

21. A data processing system for managing entries in a Web page database, the data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a notification from a client browser that a retrieval error occurred for a Web page; and automatically delete an entry associated with the Web page from the Web page database in response to receiving the notification.

22. A data processing system for removing a faulty entry from an index of Web pages, the data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a result from a server, wherein the result includes links to Web pages corresponding to a search request; request a Web page identified by a link in the links in response to a user input selecting the link; and send a notification to the server in response to an error occurring in retrieving the Web page.

23. A data processing system for managing a set of bookmarks for a browser, the data processing system comprising:
a bus system;
a communications unit connected to the bus system;
a memory connected to the bus system, wherein the memory includes as set of instructions; and
a processing unit connected to the bus system, wherein the processing unit executes the set of instructions to send a request for a Web page in response to a selection of a bookmark from the set of bookmarks in which the bookmark is associated with the Web page; and selectively remove the bookmark in response to an error in retrieving the Web page.

24. A data processing system for pruning search engine indices, the data processing system comprising:
receiving means for receiving a notification from a client browser that a Web page retrieval error occurred for a Web page or that the Web page no longer contains selected keywords; and
deleting means for automatically deleting the Web page from the search engine indices in response to receiving the notification.

25. The data processing system of claim 24, wherein the means of automatically deleting is initiated if the notification results in a minimum number of notifications being received for the Web page.

26. The data processing system of claim 24 wherein the receiving means is a first receiving means further comprising:
second receiving means for receiving a search request from the client browser, wherein the search request contains the selected keywords;
searching means for searching the search engine indices for matches to the selected keywords to form a search; and
sending means for sending a result of the search to the client browser.

27. The data processing system of claim 26, wherein the result includes an indication that the data processing system includes a search engine to cause the client browser to send the notification to the data processing system.

28. The data processing system of claim 27, wherein the search request includes other keywords in addition to the selected keywords.

29. The data processing system of claim 24, wherein the retrieval error indicates that the Web page is absent.

30. The data processing system of claim 24, wherein the data processing system is located in one of a search engine or a Web portal.

31. A data processing system for managing entries in a Web page database, the data processing system comprising:
receiving means for receiving a notification from a client browser that a retrieval error occurred for a Web page; and
deleting means for automatically deleting an entry associated with the Web page from the Web page database in response to receiving the notification.

32. The data processing system of claim 31, wherein the deleting means is initiated only if the notification causes a number of notifications received for the entry to exceed a threshold value.

33. The data processing system of claim 31 further comprising:
receiving means for receiving a search request from the client browser;
searching means for searching the Web page database for matches to the request to generate a result; and
sending means for sending the result generated from searching the Web page database to the client browser, wherein the result includes an indicator that the data processing system includes a search engine to cause the client browser to return the notification.

34. The data processing system of claim 31, wherein the notification is a first type of notification and the receiving means is a first receiving means and further comprising:
second receiving means for receiving a second type of notification from a client browser that at least one selected search term is absent from the Web page; and
deleting means for automatically deleting an entry associated with the Web page from the Web page database in response to receiving the second type of notification.

35. The data processing system of claim 31, wherein the receiving means and the deleting means are located in one of a search engine or a Web portal.

36. A data processing system for removing a faulty entry from an index of Web pages, the data processing system comprising:
receiving means for receiving a result from a server, wherein the result includes links to Web pages corresponding to a search request;
requesting means for requesting a Web page identified by a link in the links in response to a user input selecting the link; and
sending means for sending a notification to the server in response to an error occurring in retrieving the Web page.

37. The data processing system of claim 36, wherein the receiving means is a first receiving means and further comprising:
second receiving means for receiving the Web page to form a retrieved Web page; and
sending means for sending a notification to the server in response to an absence of selected keywords in the Web page.

38. The data processing system of claim 36, wherein the means is performed by a browser.

39. A data processing system for managing a set of bookmarks for a browser, the data processing system comprising:
sending means for sending a request for a Web page in response to a selection of a bookmark from the set of bookmarks, wherein the bookmark is associated with the Web page; and
removing means, responsive to an error in retrieving the Web page, for selectively removing the bookmark.

40. The data processing system of claim 39, wherein the removing means comprises:
determining means for determining whether the error has occurred more than a selected number of times; and
removing means, responsive to the error occurring more than the selected number of times, for removing the bookmark from the set of bookmarks.

41. The data processing system of claim 39, wherein the removing means comprises:
determining means for determining whether the error has occurred more than a selected number of times; and
generating means, responsive to the error occurring more than a selected amount of times, for generating a user prompt to remove the bookmark.

42. The data processing system of claim 41, wherein the removing means further comprises:
removing means for removing the bookmark in response to a user input to remove the bookmark.

43. A computer program product in a computer readable medium for pruning search engine indices, the computer program product comprising:
first instructions for receiving a notification from a client browser that a Web page retrieval error occurred for a Web page or that the Web page no longer contains selected keywords; and
second instructions for automatically deleting the Web page from the search engine indices in response to receiving the notification.

44. A computer program product in a computer readable medium for managing entries in a Web page database, the computer program product comprising:
first instructions for receiving a notification from a client browser that a retrieval error occurred for a Web page; and
second instructions for automatically deleting an entry associated with the Web page from the Web page database in response to receiving the notification.

45. A computer program product in a computer readable medium for removing a faulty entry from an index of Web pages, the computer program product comprising:
first instructions for receiving a result from a server, wherein the result includes links to Web pages corresponding to a search request;
second instructions for requesting a Web page identified by a link in the links in response to a user input selecting the link; and
third instructions for sending a notification to the server in response to an error occurring in retrieving the Web page.

46. A computer program product in a computer readable medium for managing a set of bookmarks for a browser, the computer program product comprising:
first instructions for sending a request for a Web page in response to a selection of a bookmark from the set of bookmarks, wherein the bookmark is associated with the Web page; and
second instructions, responsive to an error in retrieving the Web page, for selectively removing the bookmark.
